(19) United States
(12) Patent Application Publication
(10) Pub. No.: US 2006/0294299 A1
(43) Pub. Date: Dec. 28, 2006

(54) Techniques to verify storage of information

(75) Inventor: Samantha J. Edirisooriya, Tempe, AZ (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/169,401

(22) Filed: Jun. 28, 2005

(51) Int. Cl. G06F 12/00

(52) U.S. Cl. 711/112

(57) ABSTRACT

Techniques that can be used to verify that information requested to be stored has been successfully stored. For example, in one implementation, a signature may be assigned to information to be stored. The signature may be stored in a separate memory device from that which stores the information. To verify that the information was successfully stored, the signature may be retrieved from the separate memory device and compared against the signature stored with the information. More often than in response to a request to read information, at least one signature stored in the memory device may be requested to be identified as to be overwritten.

### FIELD

The subject matter disclosed herein relates to techniques to verify the successful storage of information.

### RELATED ART

Various techniques have been proposed for organizing data stored in data storage devices such as disk drives. One such data storage organization is referred to as Redundant Array of Independent (or Inexpensive) Disks or (RAID). In a RAID organization, two or more disk drives are employed in combination to improve fault tolerance or performance, or both. Techniques are needed to verify that data is stored in storage and memory devices as requested.

### BRIEF DESCRIPTION OF THE DRAWINGS

FIG. 1 depicts an example of a host system capable of intercommunication with a storage system.

FIG. 2A depicts an example computer system in which embodiments of the present invention may be used.

FIG. 2B depicts an example of a storage system that can be used in embodiments of the present invention.

FIG. 3 depicts an example embodiment of a storage controller, in accordance with some embodiments of the present invention.

FIG. 4 depicts an example manner by which blocks and associated block guards may be stored in a storage device.

FIG. 5 depicts an example format of a verification tag associated with a block in accordance with some embodiments of the present invention.

FIG. 6 depicts an example of logic that can be used in some embodiments of the present invention.

FIGS. 7-9 depict example flow diagrams that can be used in accordance with some embodiments of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

A phantom write may correspond to an unsuccessful write operation (e.g., uncompleted write operation) where a system that requests or performs the write operation understands that the write operation completed successfully. For example, a write cache error can cause a reported write to never reach the desired disk medium or a data block may be written to a wrong address due to a malfunctioning component of the data storage system. A silent write error may occur when a data storage system fails to write an entire block of data to the requested location, leaving data at the requested location unchanged.

At least in connection with a block write operation, one solution to prevent silent write errors and to detect phantom writes is to save a cyclical redundancy check (CRC) or other value associated with a block in a separate storage or memory device from that which stores the block. For example, the separate storage or memory device that may store the CRCs or other values (but does not store blocks) may be a non-volatile memory, although other memory devices may be used. A CRC or other value associated with the block may be stored adjacent to the block in the same storage or memory device that stores the block. If the CRC or other value is stored in a different storage or memory device from the block, then each operation to read the block may involve two read operations: (1) reading the block as well as associated CRC or other value and (2) reading the CRC or other value from the separate storage or memory device. If the CRC or other value stored with the block does not match the CRC or other value stored separately, a silent write error or phantom write or other error may have occurred and corrective actions may be taken such as but not limited to attempting to retrieve the requested block from a back-up source.

However, assuming a four (4) byte CRC and five-hundred twelve (512) byte data blocks, each one (1) gigabyte of data blocks uses eight (8) megabytes of memory space to separately store CRC or other values. For instance, an array with five (5) disks with each disk having a capacity of one-hundred-sixty (160) gigabytes requires six-point-four (6.4) gigabytes of non-volatile memory. Thus, it is desirable to minimize utilized memory space in the separate memory or storage device. Techniques are described herein which are capable of at least reducing the utilized memory space to store CRC or other values separately from storage with the associated block.

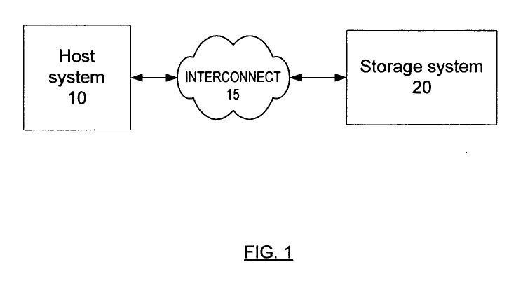

FIG. 1 depicts an example of a host system 10 capable of intercommunication with a storage system 20 using interconnect 15. Host system 10 may be implemented as any computing device, such as but not limited to, a mainframe, server, personal computer, workstation, laptop, handheld computer, telephony device, network appliance, virtualization device, and storage controller. Interconnect 15 may be capable of providing intercommunication between host system 10 and storage system 20. Interconnect 15 may include, for example, any type of network (whether wired and/or wireless) or any type of bus interface. The network may be, for example, a Storage Area Network (SAN), a Local Area Network (LAN), Wide Area Network (WAN), the Internet, and/or an intranet. Storage system 20 may be any system capable of storing information such as but not limited to data blocks.

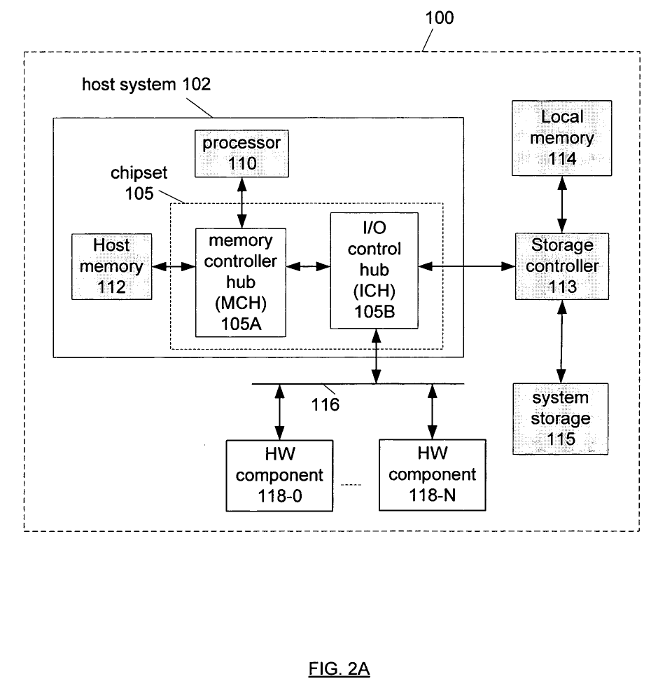

FIG. 2A depicts in computer system 100 an example system in which embodiments of the present invention may be used. Computer system 100 may include host system 102, storage controller 113, local memory 114, system storage 115, bus 116, and hardware (HW) components 118-0 to 118-N.

Host system 102 may include chipset 105, processor 110, and host memory 112. Chipset 105 may include a memory controller hub (MCH) 105A that may provide intercommunication among processor 110 and host memory 112 as well as a graphics adapter that can be used for transmission of graphics and information for display on a display device (both not depicted). Chipset 105 may further include an I/O control hub (ICH) 105B that may provide intercommunication among MCH 105A, storage controller 113, and bus 116. In one embodiment, storage controller 113 may intercommunicate with MCH 105A instead of ICH 105B.

Processor 110 may be implemented as Complex Instruction Set Computer (CISC) or Reduced Instruction Set Computer (RISC) processors, multi-core, or any other microprocessor or central processing unit. Host memory 112 may be implemented as a volatile memory device such as but not limited to Random Access Memory (RAM), Dynamic Random Access Memory (DRAM), or Static RAM (SRAM).

In accordance with an embodiment of the present invention, storage controller 113 may provide the capability to store and retrieve information to and from any of local memory 114 and system storage 115 as well as to transfer information among or within local memory 114 and/or system storage 115. In some embodiments, storage controller 113 may be communicatively coupled to MCH 105A or ICH 105B of chipset 105. For example, a PCI or PCI express compatible interface may be used to provide intercommunication between storage controller 113 and chipset 105, although embodiments are not limited in this respect. In some embodiments, storage controller 113 may be communicatively coupled to bus 116. In some embodiments, a network may communicatively couple storage controller 113 and host system 102.

Local memory 114 may be implemented as a volatile or non-volatile memory device such as but not limited to flash memory, Dynamic Random Access Memory (DRAM), battery backed up synchronous DRAM, Random Access Memory (RAM), and/or Static RAM (SRAM), however other types of memory or storage device may be used. System storage 115 may be implemented as a non-volatile storage device such as a magnetic disk drive, optical disk drive, tape drive, an internal storage device, an attached storage device, and/or a network accessible storage device. For example, system storage 115 may intercommunicate with storage controller 113 using any of the following standards: Serial Attached SCSI (SAS) described for example in Serial Attached SCSI specification 1.0 (November 2003); serial ATA described for example at “Serial ATA: High Speed Serialized AT Attachment,” Revision 1.0, published on Aug. 29, 2001 by the Serial ATA Working Group (as well as related standards) (SATA); small computer system interface (SCSI) described for example in American National Standards Institute (ANSI) Small Computer Systems Interface-2 (SCSI-2) ANSI X3.131-1994 Specification; and/or Fibrechannel described for example in ANSI Standard Fibre Channel (FC) Physical and Signaling Interface-3 X3.303:1998 Specification; although other standards may be used. Routines and information stored in system storage 115 may be loaded into host memory 112 and executed or used by processor 110. For example, system storage 115 may store an operating system as well as applications used by system 100.

Bus 116 may provide intercommunication among host system 102, storage controller 113, and HW components 118-0 to 118-N. Bus 116 may support node-to-node or node-to-multi-node communications. Bus 116 may support serial or parallel communications. Bus 116 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oregon, U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); SATA; and/or Universal Serial Bus (USB) (and related standards) as well as other interconnection standards.

Each of HW components 118-0 to 118-N may be any device capable of receiving information from host system 102 or providing information to host system 102. HW components 118-0 to 118-N can be integrated into the same computer platform as that of host system 102. HW components 118-0 to 118-N may intercommunicate with host system 102 through bus 116. For example, any of HW components 118-0 to 118-N may be implemented as a network interface capable of providing intercommunication between host system 102 and a network in compliance with formats such as, but not limited to, TCP/IP, Ethernet or SONET/SDH. For example, any of HW components 118-0 to 118-N may be implemented as a bus or interface bridge such as a PCI-to-PCI express bridge or a graphics co-processing or display interface device.

FIG. 2B depicts an example of a storage system that can be used in embodiments of the present invention. For example, storage system may include a storage controller 205, local memory 210, and system storage 215.

Storage controller 205 may control read and write operations involving system storage 215 as well as local memory 210. For example, read and write operations may be initiated by an external source such as a host system including but not limited to host system 102. For example, to intercommunicate with system storage 215, storage controller 205 may utilize standards such as but not limited to: SAS, SATA, SCSI, SCSI-2, and/or Fibre Channel, although other standards may be used.

In some embodiments, controller 205 may at least manage the generation of verification tags in connection with storage of blocks into system storage 215, the use of verification tags to verify that blocks were successfully written into system storage 215, and to identify verification tags in local memory 210 that can be overwritten. For example, in some embodiments, in connection with a read operation of data from system storage 215, local memory 210 may provide a signature from a verification tag associated with one or more block to be read from system storage 215, compare the provided signature with a signature provided from system storage 215, and if the signatures match, the requested one or more block is provided. In addition, controller 205 may indicate that the verification tag from which a signature was provided is available to be overwritten in whole in or in part. For example, in some embodiments, in response to a request to verify at least one successful block write operation, controller 205 may retrieve from local memory 210 one or more signature from one or more verification tag, retrieve from system storage 215 one or more signature stored with the blocks that are associated with the one or more verification tag, and potentially identify at least one verification tag that can be overwritten when signatures from local memory 210 and system storage 215 match.

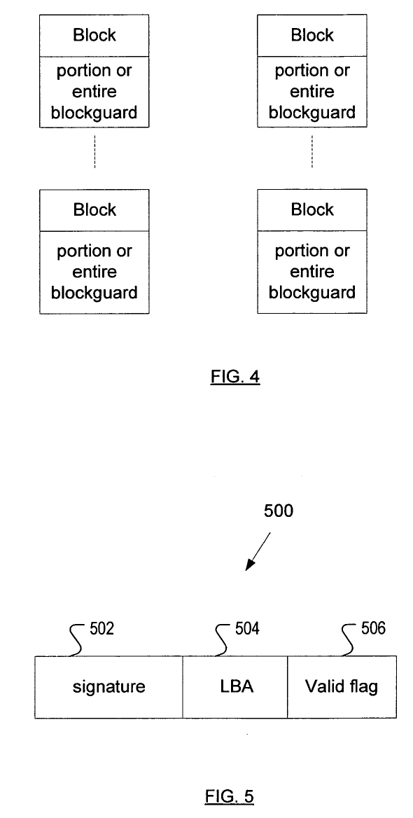

Local memory 210 may at least be capable to store verification tags, however, local memory 210 may store other information. A verification tag may be associated with data having a starting storage address at a logical block address in system storage 215. In some embodiments, a verification tag may include a signature, logical block address, and valid flag. One possible implementation of a verification tag is described with respect to FIG. 5, although embodiments are not limited in this respect. For example, local memory 210 may be implemented as a non-volatile such as but not limited to flash memory, Dynamic Random Access Memory (DRAM), battery backed up synchronous DRAM, Random Access Memory (RAM), and/or Static RAM (SRAM), however other types of memory or storage device may be used.

System storage 215 may include a storage device or an array of storage devices according to formats such as, but not limited to, any of the Redundant Array of Independent Disks (RAID) formats.

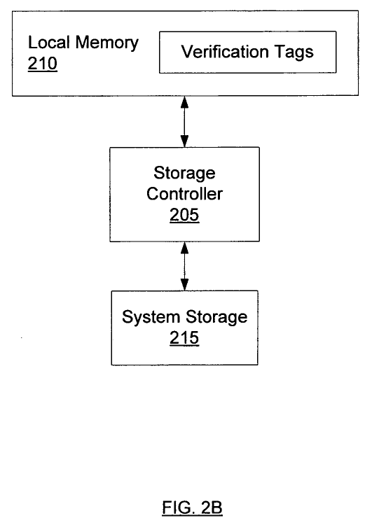

FIG. 3 depicts an example embodiment of a storage controller 300, in accordance with some embodiments of the present invention. For example, one implementation of storage controller 300 may include one or more processors 310, memory controller 315, engine 320, one or more data mover engines 325, host interfaces 330, and internal memory 335, although other implementations may be used.

Processor 310 may be implemented as Complex Instruction Set Computer (CISC) or Reduced Instruction Set Computer (RISC) processors, multi-core, or any other microprocessor or central processing unit. Processor 310 may form and process data frames and control frames in accordance with standards such as but not limited to Fiber Channel, SAS, and SATA. For example, data frames and control frames may be used in connection with read and write operations of blocks from and into storage system 215.

Memory controller 315 may control access to and from a local memory such as but not limited to local memory 210 as well as internal memory 335. In connection with a read request of one or more block from system storage 215 or a request to verify successful write operation of one or more block, memory controller 315 (or other logic) may determine whether a signature from a verification tag associated with one or more block matches a signature associated with the one or more block and retrieved from the system storage 215. If there is a match, memory controller 315 (or other logic) may indicate the verification tag can be overwritten in whole or in part. In some embodiments, a direct interface may be provided between memory controller 315 and engine 320 to bypass use of bus 340.

Internal memory 335 may store data and control frames prior to transfer in or out of system storage 215. Internal memory 335 may be implemented as a volatile memory device such as but not limited to Random Access Memory (RAM), Dynamic Random Access Memory (DRAM), or Static RAM (SRAM).

Engine 320 may include a buffer capable of storing data frames and control frames transferred between system storage 215 and other elements. For example, engine 320 may store data or other information prior to transfer to host interfaces 330, local memory, or internal memory 335 or prior to transfer to system storage 215.

Data mover engine 325 may include logic for moving data from a source to a destination without using the core processing module of a host processor, such as processor 310, or otherwise does not use cycles of a processor to perform data copy or move operations. Data mover engine 325 may be used to transfer data or other information between any memory, storage system, or logic accessible by the storage controller. For example, data mover engine 325 may be capable of transferring data or other information between host interface 330 and local (or internal) memory and vice versa. By using the data mover for transfer of data, the processor may be freed from the overhead of performing data movements, which may result in the host processor running at much slower memory speeds compared to the core processing module speeds. A data mover may include, for example, a direct memory access (DMA) engine. In some embodiments, a direct interface may be provided between data mover engine 325 and engine 320 to bypass use of bus 340.

Host interfaces 330 may provide intercommunication with a host device such as but not limited to host system. For example, host interfaces 330 may comply with standards such as but not limited to PCI Express and PCI-x.

Bus 340 may be implemented as any bus capable of providing intercommunication between multiple elements. For example, bus 340 may be implemented in a similar manner as that of bus 116.

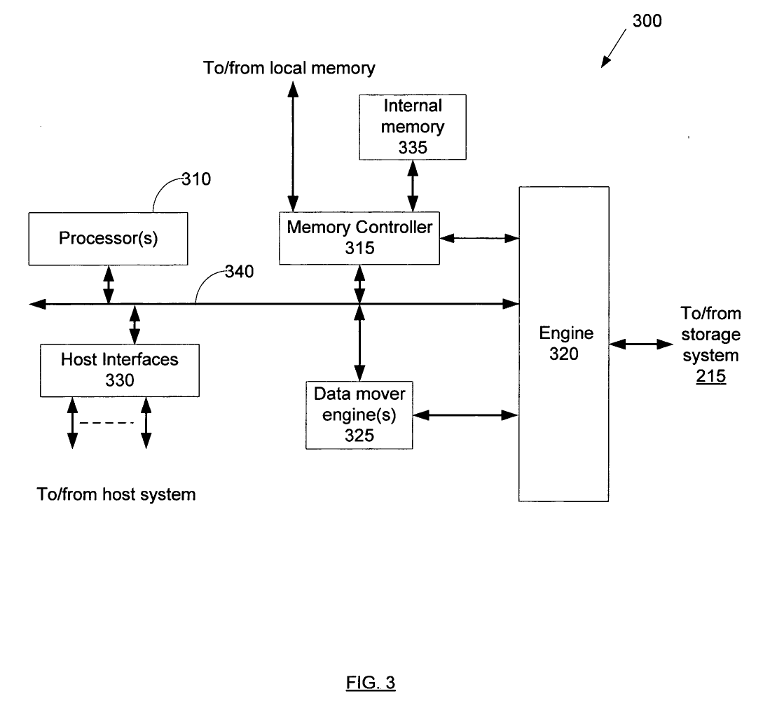

FIG. 4 depicts an example manner by which blocks and associated block guards may be stored in a storage device such as but not limited to system storage 215. A “block” may be one or more bytes of data, although other sizes may be used. A block can be identified by a first logical block address in a storage device at which the first byte of data in the block is stored or is to be stored. However, other storage schemes may be used. For example, an entire block guard associated with a block may be stored immediately after the block, although other locations may be used. In some embodiments, a block guard may include: (1) a signature; (2) a tag that specifies a logical I/O operation the block is involved with; and (3) a tag that identifies the relation of the block within the logical I/O operation. In some embodiments, a signature is computed over a portion of the block or the whole block. For example, the signature may be a cyclical redundancy check (CRC) value computed over at least a portion of the block. For example, the signature may be a checksum. A “checksum” is any numeric value used to verify the integrity of a block.

In some embodiments, the entire block guard is not stored but rather a portion of the block guard is stored immediately after the associated block. For example, in some embodiments, the stored portion may be a signature.

FIG. 5 depicts an example format of a verification tag associated with a block in accordance with some embodiments of the present invention. For example, a verification tag 500 may include a signature 502, logical block address (LBA) 504, and valid flag 506. In some embodiments, a verification tag 500 is associated with each block stored at an LBA in a system storage such as but not limited to system storage 215.

For example, signature 502 may be calculated in a similar manner as a signature portion of a block guard. For example, a signature may be a value calculated over a portion of a block or over the entire block.

LBA 504 may be a portion of a starting logical block address at which an associated block is stored. For example, LBA 504 may be used to identify a verification tag (or portion of the verification tag) associated with a block.

Valid flag 506 may be used to indicate whether a portion of a verification tag can be overwritten. For example, in some embodiments, a signature portion of a verification tag can be overwritten, although other portions of the verification tag may be overwritten. For example, valid flag 506 may be set to zero (0) to indicate that signature 502 of verification tag 500 may be overwritten (although other portions of the verification tag may be overwritten) whereas valid flag 506 may be set to one (1) to indicate that the verification tag 500 may not be overwritten.

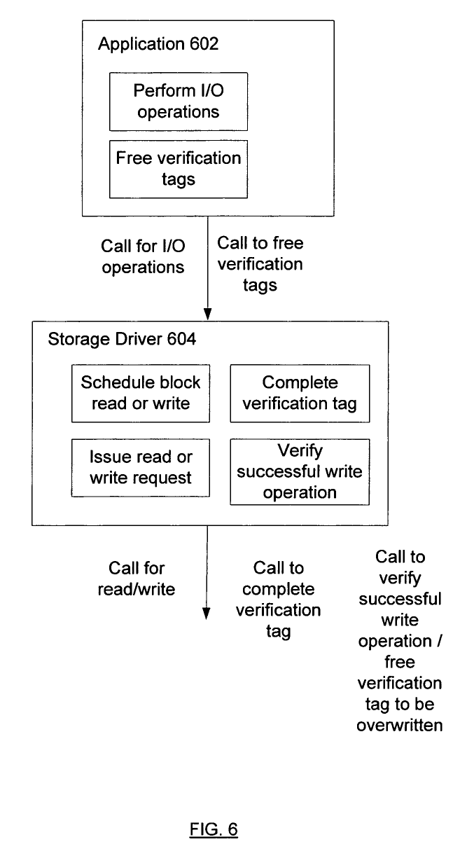

FIG. 6 depicts an example of elements that can be used to request block writes, block reads, as well as verifying successful write operations and identifying verification tags that can be overwritten, in accordance with some embodiments of the present invention. However, other implementations may be used.

Application 602 may be machine-executable instructions that may determine how to process input/output (I/O) operations posted by logic such as a host computer. For example, an I/O operation may include a write or read request for one or more blocks stored in a storage device such as system storage 215. Application 602 may determine when to perform read and write operations involving blocks in the storage device as well as when to perform operations that can free verification tags to be overwritten in local memory such as local memory 210 (such as a request to verify at least one successful block write operation). Application 602 may be executed by one or more processor such as but not limited to processor 110.

Storage driver 604 may be machine-executable instructions that schedule one or more read or write requests for blocks in the storage device in response to a call for an I/O operation as well as issue one or more read or write requests for blocks in the storage device in response to a call for an I/O operation. Storage driver 604 may at least further issue requests to complete a verification tag in conjunction with a block write into the storage device, verify a successful write operation (and potentially free verification tags to be overwritten) in conjunction with either a block read request to the storage device or a request to free verification tags. Storage driver 604 may be executed by one or more processor in the storage controller such as but not limited to processor 310.

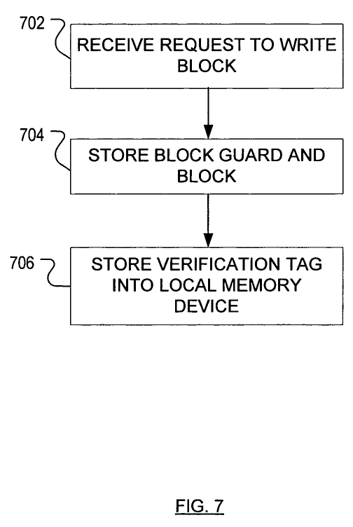

FIG. 7 depicts an example flow diagram that can be used to write one or more block as well as associated verification tag(s) in accordance with an embodiment of the present invention.

In block 702, the process may receive a request to write one or more block starting at a specified logical block address. For example, the block may be designated to be written in a storage device such as system storage 215.

In block 704, the process may store the block and associated block guard into the storage device. For example, the block guard may be created by data mover logic while the data mover logic is in the process of transferring blocks for storage into the storage device. However, other logic such as a processor unit in a storage controller may create the block guard. The block and block guard (or portion of the block guard) may be stored according to the order described with respect to FIG. 4.

In block 706, the process may store a verification tag associated with the block into a local memory device. For example, when a verification tag associated with the starting logical block address at which the block is stored in block 704 is not stored in the local memory device, the verification tag may be created and stored into the local memory device. The signature, logical block address, and valid tag fields of such verification tag may be populated with the signature in the block guard unit of the block, the starting logical block address of the block, and a valid tag indicating that the verification tag is not to be overwritten. For example, the verification tag may be generated by a storage controller and stored into the local memory device, however other logic may be used to generate the verification tag. For example, the verification tag associated with the starting logical block address at which the block is stored in block 704 may have been previously stored in the local memory device. For example, signature and valid flag portions of the previously stored verification tag may be populated with the signature from the block guard stored in block 704 as well as a valid flag indicating that the verification tag is not to be overwritten. In some embodiments, a verification tag with a valid flag set to indicate the verification tag is not to be overwritten may be overwritten.

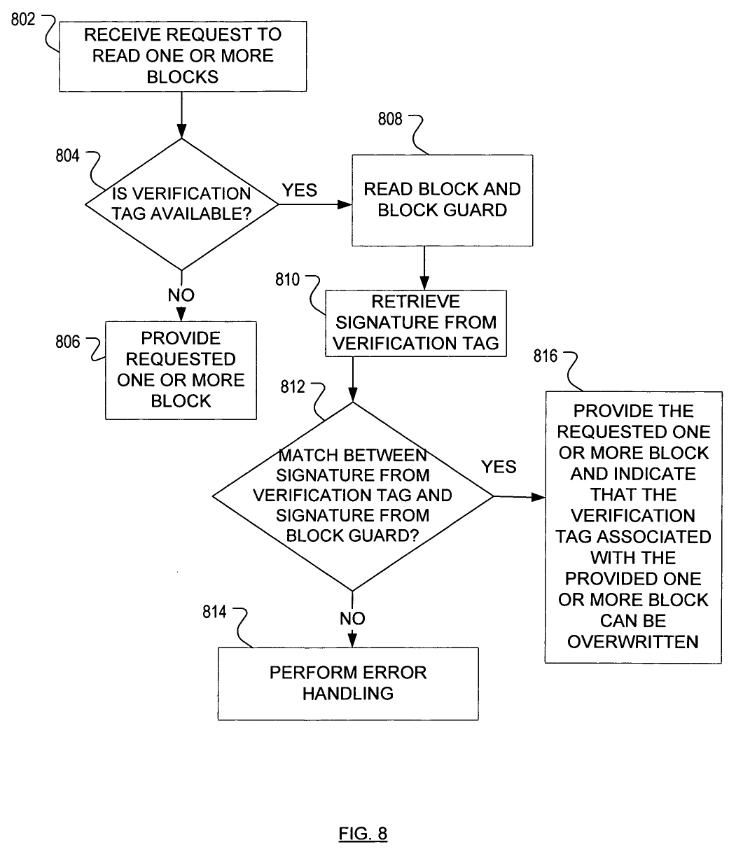

FIG. 8 depicts an example flow diagram of a process that can be used to retrieve one or more block in accordance with an embodiment of the present invention. In block 802, the process may receive a request to read one or more blocks from a storage device, such as but not limited to system storage 215.

In block 804, the process may determine whether the verification tag associated with the requested one or more block is available. For example, a verification tag may be available when a verification tag having a logical block address field associated with the requested one or more block is stored in the local memory. The local memory may be a non-volatile memory. If the verification tag is available, then block 808 follows. If the verification tag is not available, then block 806 follows.

In block 806, the process may provide the requested one or more block from the storage device. For example, block 806 may correspond to the successful write of the one or more block having been previously verified using a verification tag associated with the one or more block. In that previous verification, the verification tag may have been freed to be overwritten and was thereafter overwritten.

In block 808, the process may read the one or more requested block and associated block guard from the storage device such as but not limited to system storage 215. In some embodiments, in block 808, the process may read the one or more requested block and associated signature from the storage device such as but not limited to system storage 215. In block 810, the process may retrieve the signature portion of a verification tag associated with the requested one or more block.

In block 812, the process may determine whether the signature retrieved from the verification tag matches a signature from the block guard retrieved in block 808. If the signatures match, then block 816 follows. If signatures do not match, then block 814 follows.

In block 814, the process may perform error handling. For example, error handling may include accessing a back-up copy of the block.

In block 816, the process may provide the requested one or more block and indicate that the verification tag associated with the provided one or more block can be overwritten. For example, indicating a verification tag can be overwritten may include setting a valid bit of the verification tag to zero or otherwise indicating that all or a portion of the verification tag may be overwritten.

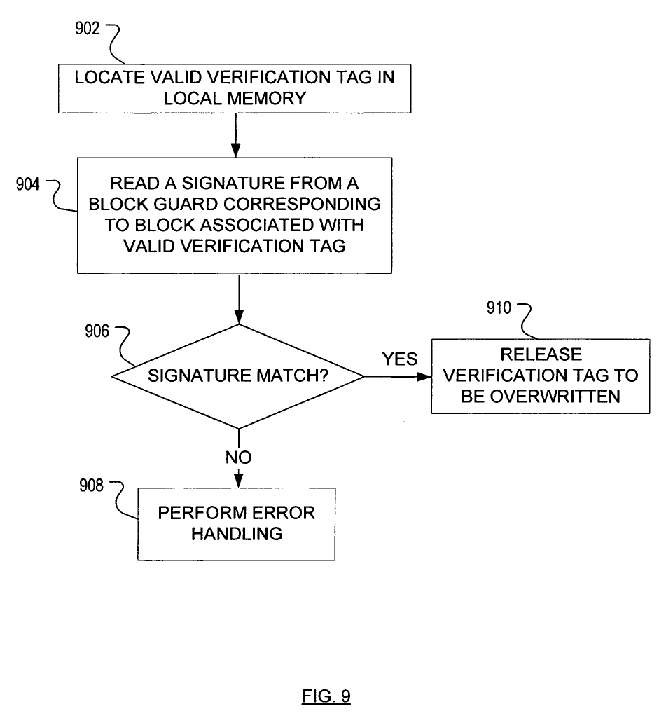

FIG. 9 depicts a flow diagram of an example process that can be used to verify whether a successful block write operation occurred and to determine whether any verification tag (including a portion of any verification tag) can be overwritten, in accordance with an embodiment of the present invention. For example, the process of FIG. 9 may be performed when scheduled such as by application 602, although other logic may be used. For example, the application may schedule performing the process of FIG. 9 when no I/O activities involving blocks in a storage device are scheduled to occur.

In block 902, the process may locate a valid verification tag in local memory.

In block 904, the process may read a signature from a block guard corresponding to a block associated with the located valid verification tag.

In block 906, the process may determine whether the signature from the block guard matches the signature from the verification tag. If the signature from the block guard matches the signature from the verification tag, block 910 follows. If the signature from the block guard does not match the signature from the verification tag, block 908 follows.

In block 908, the process may perform error handling. For example, error handling may be similar to that described with respect to block 814.

In block 910, the process may release the verification tag to be overwritten. For example, verification tag may be released to be overwritten by setting valid bit of the verification tag to indicate the verification tag (in whole or in part) can be overwritten. However, other techniques may be used to release a verification tag to be overwritten.

Accordingly, one advantage but not a necessary feature of any embodiment, is that memory space used to store verification tags can be reduced by identifying verification tags to overwrite.

Embodiments of the present invention may be implemented as any or a combination of: microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
storing a plurality of blocks and a plurality of first signatures, wherein each first signature is associated with at least one of the plurality of blocks;
storing in a memory device a plurality of verification tags, wherein each verification tag includes a second signature and wherein each verification tag is associated with at least one of the plurality of blocks; and
verifying successful storage of at least one block based on a comparison between first and second signatures associated with the at least one block.

2. The method of claim 1, wherein at least one verification tag comprises a flag to identify whether at least a portion of the verification tag is available to be overwritten.

3. The method of claim 2, wherein the at least one verification tag comprises a logical block address to identify an associated block.

4. The method of claim 1, wherein the first and second signatures each comprise cyclical redundancy check (CRC) values.

5. The method of claim 1, wherein the verifying comprises:
comparing a first signature associated with a particular block with a second signature associated with the particular block; and
identifying at least a portion of the verification tag associated with the particular block as available to be overwritten.

6. The method of claim 1, wherein the verifying occurs at least in response to a request to read a block.

7. The method of claim 1, wherein the verifying occurs at least in response to a request to identify at least one verification tag to be overwritten.

8. The method of claim 1, further comprising:
receiving a request to provide a requested block; and
selectively providing the requested block in response to a first signature associated with the requested block matching a second signature associated with the requested block or in response to the memory device not providing the second signature.

9. The method of claim 1, further comprising overwriting a portion of at least one verification tag identified to be overwritten.

10. An apparatus comprising:
logic to store a plurality of blocks and a plurality of first signatures, wherein each first signature is associated with at least one of the plurality of blocks;
logic to store in a memory device a plurality of verification tags, wherein each verification tag includes a second signature and wherein each verification tag is associated with at least one of the plurality of blocks; and
logic to verify successful storage of at least one block based on a comparison between first and second signatures associated with the at least one block.

11. The apparatus of claim 10, wherein at least one verification tag comprises a flag to identify whether at least a portion of the verification tag is available to be overwritten.

12. The apparatus of claim 11, wherein the at least one verification tag comprises a logical block address to identify an associated block.

13. The apparatus of claim 10, wherein the first and second signatures each comprise cyclical redundancy check (CRC) values.

14. The apparatus of claim 10, wherein the logic to verify comprises:
logic to compare a first signature associated with a particular block with a second signature associated with the particular block; and
logic to identify at least a portion of the verification tag associated with the particular block as available to be overwritten.

15. The apparatus of claim 10, wherein the logic to verify is to verify at least in response to a request to read a block.

16. The apparatus of claim 10, wherein the logic to verify is to verify at least in response to a request to identify at least one verification tag to be overwritten.

17. The apparatus of claim 10, further comprising:
logic to receive a request to provide a requested block; and
logic to selectively provide the requested block in response to a first signature associated with the requested block matching a second signature associated with the requested block or in response to the memory device not providing the second signature.

18. The apparatus of claim 10, further comprising logic to overwrite a portion of at least one verification tag identified to be overwritten.

19. A computer-readable medium comprising instructions stored thereon which when executed by a machine cause the machine to:
store a plurality of blocks and a plurality of first signatures, wherein each first signature is associated with at least one of the plurality of blocks;
store in a memory device a plurality of verification tags, wherein each verification tag includes a second signature and wherein each verification tag is associated with at least one of the plurality of blocks; and
verify successful storage of at least one block based on a comparison between first and second signatures associated with the at least one block.

20. The computer-readable medium of claim 19, wherein at least one verification tag comprises a flag to identify whether at least a portion of the verification tag is available to be overwritten.

21. The computer-readable medium of claim 20, wherein the at least one verification tag comprises a logical block address to identify an associated block.

22. The computer-readable medium of claim 19, wherein the first and second signatures each comprise cyclical redundancy check (CRC) values.

23. The computer-readable medium of claim 19, wherein the instructions to verify comprise instructions to:
compare a first signature associated with a particular block with a second signature associated with the particular block; and
identify at least a portion of the verification tag associated with the particular block as available to be overwritten.

24. A system comprising:
a host system comprising a processor;
a storage device capable to store a plurality of blocks and a plurality of first signatures, wherein each first signature is associated with at least one of the plurality of blocks;
a memory device capable to store a plurality of verification tags, wherein each verification tag includes a second signature and wherein each verification tag is associated with at least one of the plurality of blocks;
a storage controller communicatively coupled to the host system and to provide information transfer between the host system and the storage device, wherein the storage controller includes:
logic to verify successful storage of at least one block based on a comparison between first and second signatures associated with the at least one block.

25. The system of claim 24, wherein at least one verification tag comprises a flag to identify whether at least a portion of the verification tag is available to be overwritten.

26. The system of claim 25, wherein the at least one verification tag comprises a logical block address to identify an associated block.

27. The system of claim 24, wherein the first and second signatures each comprise cyclical redundancy check (CRC) values.

28. The system of claim 24, wherein the logic to verify comprises:
logic to compare a first signature associated with a particular block with a second signature associated with the particular block; and
logic to identify at least a portion of the verification tag associated with the particular block as available to be overwritten.
